(19) United States
(12) Patent Application Publication
(10) Pub. No.: US 2002/0059075 A1
(43) Pub. Date: May 16, 2002

(54) Method and system for managing a land-based vehicle

(76) Inventors: Louis A. Schick, Delmar, NY (US); James Edward Schlabach, Erie, PA (US); Nunzio Peleggi, Slingerlands, NY (US); John Yupeng Gui, Niskayuna, NY (US)

Correspondence Address: BEUSSE, BROWNLEE, BOWDOIN & WOLTER, P. A., 390 NORTH ORANGE AVENUE, SUITE 2500, ORLANDO, FL, 32801, US

(21) Appl. No.: 09/844,089

(22) Filed: Dec. 3, 2001

Related U.S. Application Data
(63) Continuation-in-part of application No. 09/644,420, filed on Aug. 23, 2000.
(63) Continuation-in-part of application No. 09/736,495, filed on Dec. 13, 2000.
(60) Provisional application No. 60/201,243, filed on May 1, 2000.

(51) Int. Cl. G06F 17/60

(52) U.S. Cl. 705/1

(57) ABSTRACT

Method and system for managing a land-based vehicle is provided. The method allows to provide a database configured to store a rule base for governing prescribed usage of a vehicle and for gathering predetermined data indicative of the actual use of the vehicle. As the vehicle is in motion and using onboard sensors, the method further allows to monitor at least one parameter relating to the use of the vehicle. A transmitting action allows to transmit data relating to the vehicle parameter for each vehicle to the database. A processing action allows to process the transmitted data relative to the predetermined data to determine whether or not the actual use of each vehicle is compliant with the prescribed usage of the vehicle as set forth in the rule base. A notifying action allows to notify a user of the vehicle of any non-compliance.

This application is a continuation-in-part of co-pending and commonly assigned U.S. patent application Ser. Nos. 09/644,420 filed Aug. 23, 2000; and 09/736,495 filed Dec. 13, 2000; and further claims the benefit of U.S. patent application Ser. No. 60/201,243 filed May 1, 2000.

### BACKGROUND OF THE INVENTION

The present invention relates generally to the field of managing a vehicle. In one exemplary embodiment, the invention is described in the application of managing a land-based vehicle, and, more particularly, in the application of managing a fleet of such vehicles.

The management of a large fleet of remote assets, particularly when the fleet of assets comprises a fleet of vehicles, such as a fleet of trucks, railway transportation equipment, or other land-based vehicles is a challenging logistical effort. There is continuing pressure for the owners and/or lessors, of such assets to improve the efficiency of operations of the assets to remain competitive in the market place. For example, railroads must manage their fleets of locomotives to maximize the on-train time in order to remain competitive with alternative modes of transportation. The assignee of the present invention is a supplier of locomotive engines and has developed numerous design features and services to maximize the efficiency of operation of its locomotives. The assignee of the present invention has also undertaken to provide integrated maintenance services to the owners and/or lessors of vehicles. Such services may include managing fleet-related data among a plurality of maintenance service centers that supply necessary parts and labor. The coordination of the servicing of a large fleet of vehicles and the communication with the various parties involved in such efforts are monumental tasks.

U.S. Pat. 5,845,272 dated Dec. 1, 1998, commonly owned with the present invention, describes a system and method for diagnosing failures in a locomotive. While such a system and method has proven beneficial, further improvements in fleet management are desired.

Additionally, operations of vehicles such as commercial trucks, fleets of leased cars and even private vehicles are generally burdened by overspending on maintenance both in direct costs and in lost productivity of the assets due to unduly conservative maintenance schedules. Such schedules may generally represent the extreme asymmetry in effective cost of planned versus unplanned down time of the vehicles. Thus, reliable and inexpensive data management services targeted at such assets, and, more specifically, to their operators is desirable. Dynamically and personalized timely delivery of information to operators of the remote assets presents a substantial opportunity for productivity enhancement of the assets, operators and financial investment of the service providers. Location information, as may be available through various navigation systems, such as a Global Positioning System (GPS) and other transponder-based systems, has yet to be leveraged in a systematic manner which enables cost-effective logistics planning, maintenance planning and targeted marketing. Various features available onboard the remote assets have not yet been fully exploited for usage profiling, planning, diagnostics, prognostics or subsystem optimization in the vehicles. Examples of such features include computerized control of various subsystems used for operation of the remote assets, e.g., propulsion subsystem, climate control, engine, etc., local storage of fault codes and buffering, and storage and data reduction of analog or digital data that such subsystems automatically generate during their operation. U.S. patent application Ser. No. 09/736,405 filed Dec. 13, 2000, commonly owned by the same assignee of the present invention, discloses system and techniques believed to appropriately address the foregoing shortcomings of presently implemented practices.

For the reasons set forth below, it would be further desirable to provide improved techniques and system for managing and communicating data indicative of actual vehicle use that may be used to determine whether or not each vehicle is compliant with the prescribed usage of the vehicle. One example of a parameter relating to the use of the vehicle that may be monitored using suitable onboard sensors may comprise cargo weight. Other parameters that may be monitored may include engine emissions, operator log entries, brake equipment health status, etc.

The weight onboard a vehicle is often of crucial importance, especially to carriers in transportation industries, such as the trucking or railroad industries. For example, the cost of delivering cargo for commercial purposes is generally assessed to the customer according to the weight of the cargo or load and the distance it must travel. Knowledge of cargo weight is therefore necessary to ensure that the customer is assessed the full price of transporting the cargo. Weight information can also be used to optimize the cargo at or near the vehicle's maximum capacity.

It is known that vehicle operators have relied on private or government-operated stationary platform scales or weigh stations for cargo weight information. Unfortunately, the stationary scale may be located inconveniently far away from the customer's loading dock. Thus, the vehicle operator has had to rely on the customer or shipping broker's quoted cargo weight or must travel, sometimes out of his or her way, to the nearest stationary scale for an accurate measurement. If the cargo weight quote proves erroneous at a stationary scale, the vehicle operator may have to return to the customer's loading dock to obtain full payment. The vehicle operator's inability to accurately determine the cargo weight at the loading dock, therefore, can result in wasted operator time, wasted vehicle travel mileage and time, and erroneous freight charges.

The weight of commercial cargo vehicles is also important from the perspective of public safety, highway and railway maintenance. Overloading a commercial cargo vehicle can create a hazard by reducing the vehicle's stability and braking ability. An overloaded commercial cargo vehicle also causes greater wear to highways or railways and to the vehicle itself. Governmental agencies therefore regulate vehicle weight by specifying a maximum legal cargo limit. Stiff fines are usually levied against operators who are found violating these regulations. Unfortunately, the cargo limit regulations have been generally enforced using the same stationary platform scales relied on by operators to determine a vehicle's loaded weight for pricing purposes. Vehicle operators may therefore lack the ability to detect non-compliance before being subject to liability for overloading.

The foregoing disadvantages of platform scales have been reduced somewhat by using portable platform scales that can be placed under each set of wheels. Such platform scales are carried from place to place in the vehicle. However, such scales are generally costly and cumbersome. For example, it is time consuming to place these scales beneath the individual sets of wheels and move the vehicle onto the scales in order to measure axle weights. To try to alleviate the foregoing problems, onboard vehicle weighing systems have been developed. In these systems, load cells or other weight-sensing transducers are secured to structural members of the vehicle in order to obtain axle weights. Accordingly, it is known that on-board weighing systems offer some advantages over stationary scales. With on-board weighing systems, vehicle operators can determine vehicle weight at the loading dock or while under way to ensure accurate freight charge calculation, optimize cargo weight, and voluntarily comply with cargo limits.

Various on-board weighing devices are known. The devices have employed various weight sensor apparatus for sensing the weight of the vehicle's cargo, including load cells, strain gauges, displacement transducers on leaf or coil spring suspended vehicles, or pressure transducers on height-leveled, air spring suspended vehicles. The various weight sensor apparatus generate an electrical signal related to the cargo weight of the vehicle. Generally, the prior devices may include a cab-mounted read-out device for displaying the vehicle's cargo weight in response to a weight sensor signal.

A drawback of prior on-board weighing systems is that vehicles equipped with such systems are still subject to relatively time-consuming, paper-intensive and burdensome stops in order to be weighed for apportionment of tariffs and safety audits by the governmental inspectors. Overweight vehicles are subject to fines, delays and even seizure of assets to prevent safety issues and avoidance of apportioned tariffs or taxes. Unfortunately, the foregoing procedures consume valuable productivity of the operator, the vehicle, and carried goods as well as deplete scarce governmental manpower resources. Further, it is believed that implementation of various global or regional trade agreements (e.g., NAFTA (North America Free Trade Agreement)) may further increase the volume of vehicles travelling on the highways or railways of any given nation. Thus, it would be desirable to provide automated, wireless communication system and techniques that would enable for weighing the vehicles without having to routinely stop and wait at any inspection or auditing station, either private or government-operated. It is believed that providing weight information of the vehicle on the fly, e.g., using “weigh as you go” techniques, will substantially ameliorate the foregoing drawbacks. It would be further desirable to quickly and inexpensively be able to reliably and accurately disseminate vehicle information indicative of actual use of the vehicle including weight data information over a global communications network, such as the Internet, so that users that manage the fleet of vehicles, their customers and governmental agencies may benefit from the online availability of such information using a 24×7 essentially automated computer-based operation. That is, an operation generally available every day of the week, each of the 24 hours of the day, with minimal human intervention, if any, and accessible with commercially available technologies, e.g., Web-based technology.

### BRIEF SUMMARY OF THE INVENTION

Accordingly, a system and method are described herein for effectively integrating the diverse elements involved in the management of a vehicle, e.g., a land-based vehicle. In one aspect thereof, the invention makes use of the data management powers of modern computer and global information networks by using such tools to collect, store, analyze, distribute and present information in a format and at a time when it can be used most effectively by people responsible for each vehicle.

Some aspects that may be achieved by the invention may include real-time data collection from each vehicle, computerized processing of such data for determining whether or not the actual use of each vehicle is compliant with the prescribed usage of the vehicle. The various participants and stakeholders in these activities are provided with appropriate levels of information via a global information network. The information presentation power of the multi-media format of an Internet web site may be ideally suited in one exemplary embodiment for accomplishing many of the communication functions for implementing this invention.

Other aspect of the invention includes a method for managing a land-based vehicle. The method allows to provide a database configured to store a rule base for governing prescribed usage of a vehicle and for gathering predetermined data indicative of the actual use of the vehicle. As the vehicle is in motion and using onboard sensors, a monitoring action allows to monitor at least one parameter relating to the use of the vehicle. A transmitting action allows to transmit data relating to the vehicle parameter for each vehicle to the database. A processing action allows to process the transmitted data relative to the predetermined data to determine whether or not the actual use of each vehicle is compliant with the prescribed usage of the vehicle as set forth in the rule base. A notifying action allows to notify a user of the vehicle of any non-compliance.

Another aspect of the invention includes providing a database configured to store a rule base for governing prescribed usage of a vehicle and for gathering predetermined data indicative of actual use of the vehicle, wherein the database is part of an inspection site. As the vehicle is in motion and using onboard sensors, a monitoring action allows to monitor at least one parameter relating to the use of the vehicle. A transmitting action allows to transmit data relating to the vehicle parameter including a unique identifier for each vehicle to the inspection site as the vehicle approaches the site. A processing step allows to process the transmitted data relative to the predetermined data to determine whether or not actual use of each vehicle is compliant with the prescribed usage of the vehicle as set forth in the rule base.

Still another aspect of the invention includes a system for managing a land-based vehicle. The system includes a database configured to store a rule base for governing prescribed usage of a vehicle and for gathering predetermined data indicative of actual use of the vehicle. The system further includes onboard sensors configured to monitor, as the vehicle is in motion, a parameter relating to the use of the vehicle. A transceiver is configured to transmit data relating to the vehicle parameter for each vehicle to said database. A processor is coupled to the database to determine whether or not the actual use of each vehicle is compliant with the prescribed usage of the vehicle as set forth in the rule base. A module is configured to notify a user of the vehicle of any non-compliance.

Yet another aspect of the invention includes a system for managing a land-based vehicle. The system includes a database configured to store a rule base for governing prescribed usage of a vehicle and for gathering predetermined data indicative of the actual use of the vehicle, wherein said database is part of an inspection site. Onboard sensors are configured to monitor, while the vehicle is in motion, a parameter relating to the use of the vehicle. A transceiver is configured to transmit data relating to the vehicle parameter including a unique identifier for each vehicle to the inspection site as the vehicle approaches the site. A processor is coupled to the database to determine whether or not the actual use of each vehicle is compliant with the prescribed usage of the vehicle as set forth in the rule base.

### BRIEF DESCRIPTION OF THE DRAWINGS

The features and advantages of the present invention will become apparent from the following detailed description of the invention when read with the accompanying drawings in which:

FIG. 1 is a schematic illustration of an exemplary communications network for managing a fleet of vehicles.

FIG. 2 illustrates exemplary steps of a method for managing a fleet of vehicles.

FIG. 3 is a block diagram of an exemplary system for communicating data from a vehicle.

FIG. 4 is a block diagram of a monitoring station apparatus of the system shown in FIG. 3.

FIG. 5 illustrates an exemplary web page that may be used for meeting a contractual obligation to report out on usage of a fleet of trucks.

FIG. 6 illustrates an exemplary “pie chart” plot that indicates the amount of time a given set of vehicles may have spent in respective operational modes indicative of a respective state of health of the assets.

FIG. 7 shows a flowchart of a method for managing a land-based vehicle in accordance with one aspect of the present invention.

FIG. 8 shows a flowchart of a method for managing a land-based vehicle in accordance with another aspect of the present invention.

FIG. 9 illustrates an exemplary schematic of a system that may be used for practicing aspects of the present invention, such as the respective methods illustrated in FIGS. 7 and 8.

FIG. 10 provides further details of the system of FIG. 9 including an exemplary installation of sensors for monitoring cargo weight onboard the vehicle.

FIG. 11 illustrates an exemplary arrangement of a transponder tag that may be used by the system of FIG. 10.

### DETAILED DESCRIPTION OF THE INVENTION

To effectively manage each vehicle in a fleet of vehicles, it is necessary to avoid unexpected equipment failures and to accomplish compliance, maintenance, and repair activities in a time efficient manner. There is a tremendous amount of information available related to a fleet of vehicles. Such information may include design information, real time operating data, historical performance data including failure probabilities, parts inventories, and geographic information related to the assets, cargo being transported with the assets, parts, personnel and repair facilities, etc. Key to achieving efficient operation is the ability to communicate such information to people and places where it is needed, and to present the information in a format that makes it useful to accomplish the desired result.

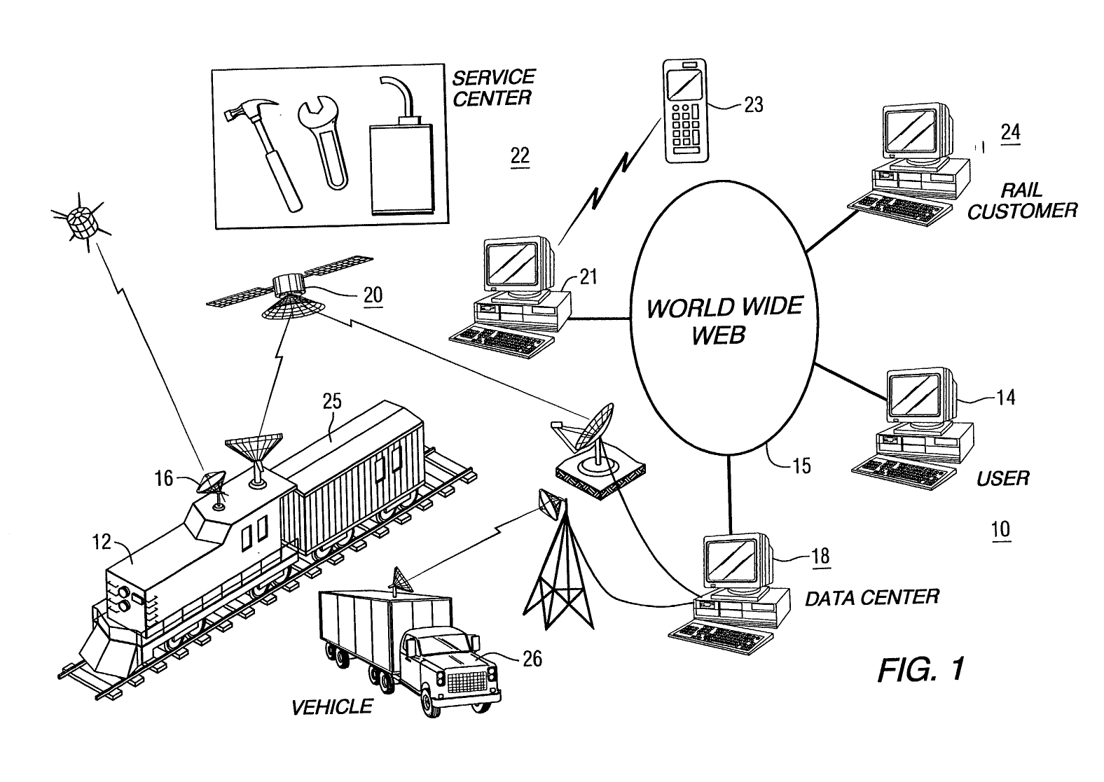

In one exemplary embodiment, the system 10 of FIG. 1 may be used for managing a fleet of remote assets. Although primarily illustrated and described with respect to a fleet of vehicles, such as a fleet of locomotives 12, or a fleet of trucks and/or tractor trailers 26, the invention may be implemented with other types of remote land-based assets that may be deployed at a particular site for an extended period of time, such as crane loading equipment based on a port, excavation mining equipment based on a mine, agricultural farming equipment based on a farm, etc. Furthermore, the apparatus and method described herein are useful for managing not only mobile vehicles but also the cargo transported with such vehicles and dedicated subsystems that may be used for accomplishing the principal utility of the asset, such as the hoisting subsystem that may be used in a “cherry picker” truck, or the refrigeration subsystem used in a refrigerated vehicle. The data management system 10 allows a variety of different types of users to obtain detailed and timely information regarding each of the vehicles, e.g., 12 or 26. By way of example, such users may include a transportation company 14 who owns and operates the remote assets, may include original equipment manufacturers (OEMs) that assemble the vehicle and lease such assets to respective end users, or may include personnel empowered to enforce rules relative to the prescribed use of the vehicle, e.g., personnel associated with governmental agencies, such as the Department of Transportation (DOT) or similar agencies. The users may include a customer 24 or personnel of the transportation company and/or the OEM, personnel in an asset service center 22, personnel in a data center 18, and the engineer or driver that operates each individual asset. The vehicles, e.g., 12 or 26, may be equipped with a plurality of sensors for monitoring a plurality of operating parameters representative of the condition of the remote asset and of the efficiency of its operation. The vehicles, e.g., 12 or 26, may also be equipped with a GPS receiver 16 or other satellite-based or local navigation instrument for determining the geographic location of the vehicle. Data regarding the location of the vehicle and its operating parameters may be transferred periodically or in real time to a data base 18 by a data link 20, such as a satellite system, cell phone, optical or infrared system, hard-wired phone line, etc. By way of example, the assignee of the present invention operates such a data center 18 at its Monitoring and Diagnostics Service Center (MDSC) in Erie, Pa. Affiliated with such a data center 18 may be one or more service centers 22 where the vehicles are taken for repair and maintenance services.

As illustrated in FIG. 1, the data center 18 and service center 22 may both be linked to a global information network, such as the Internet 15, by known types of data connections. Such links may typically be a computer interface through an internet service provider. The Internet and World Wide Web provide a means for communicating between the data center 18 and service center 22. Furthermore, these facilities may also be in communication with the transportation company user 14 via an Internet connection. Customers 24 of the transportation company or other members of the public may further be in communication with these facilities through Internet links. Because the Internet 15 and known web page formats provide cost-effective means for communicating data and information in a multi-media format, such a global information network is one example of a useful communication tool for displaying and communicating the large amount of data that may be associated with the operation of a fleet of vehicles, e.g., 12 or 26.

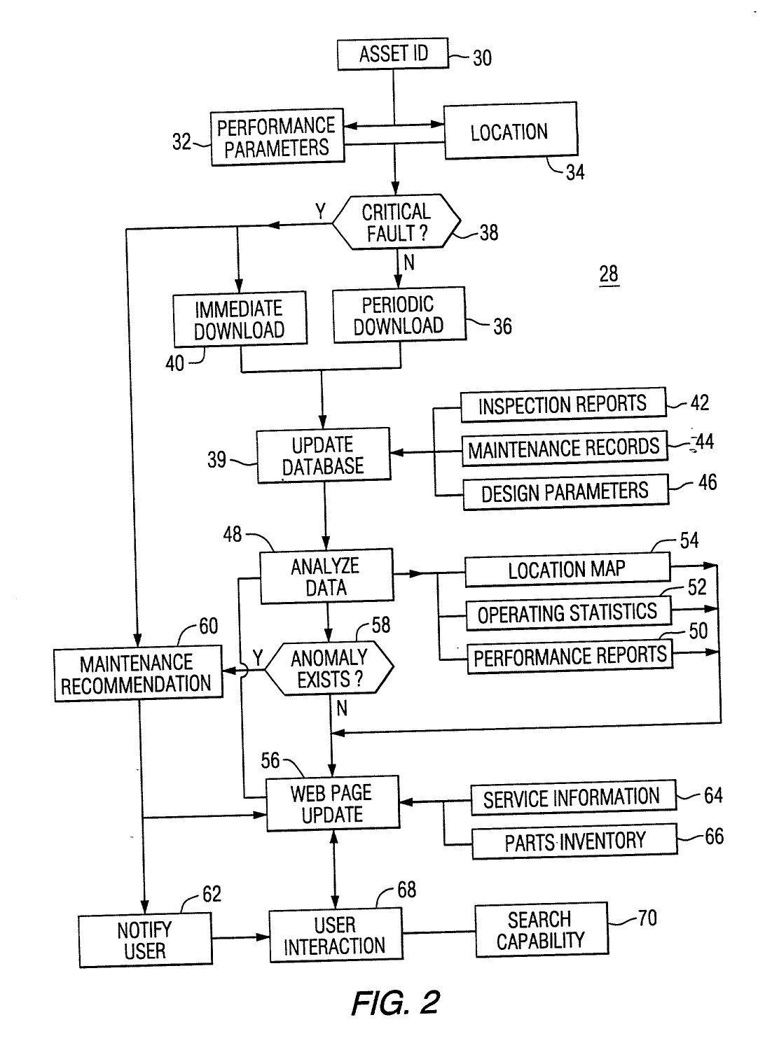

FIG. 2 illustrates exemplary steps of a method 28 for managing a fleet of vehicles that may be implemented by using a data management system 10 as illustrated in FIG. 1. Each vehicle may be uniquely identified, such as by an identification number, as in step number 30 of FIG. 2. One or more identifiers may also be associated with the cargo being transported with the vehicles, e.g., 12 or 26. For respective embodiments of either the fleet of locomotives 12 or the fleet of trucks 26, the operating parameters of each of the vehicles may be monitored 32 by the on-board sensors. In one exemplary embodiment, such operating parameters are monitored in real time, and data related to these operating parameters is available for communication to a data center 18 whenever appropriate. The location of each asset is also determined 34, such as by using a GPS receiver or by otherwise identifying the vehicle relative to a particular location along the route of the asset. Data regarding both the location and the operating parameters for each vehicle, e.g., 12 or 26, may be periodically downloaded 36 from an on-board data file to a centralized data base 39. The data may further include environmental conditions to which each vehicle has been exposed to during their operation. Example of such data may include temperature, barometric pressure, terrain topography, humidity level, dust level, etc. In the event that a critical fault is identified 38 in one of the systems of a vehicle, it may be preferred to download data from the vehicle immediately 40 upon recognition of the fault. The timing of the download may also be determined based upon the availability and quality of the data link 20 between the vehicle and the data center 18.

The database 39 located at the data center 18 may also include data representing inspection reports 42, maintenance records 44, and design information 46 related to the specific vehicles included in the plurality of vehicles. For example, if a truck 26 is brought to a service center 22 for a periodic inspection and maintenance visit, e.g., regarding its braking equipment, information regarding the results of the inspection and maintenance activities may be used to update the database 39 for that particular truck 26. It will be appreciated that in one exemplary embodiment, the service center may comprise an inspection station empowered to enforce laws and regulations relating to the use of the vehicle. The database may also be updated 39 if the designer of the vehicle provides any revised design parameters 46, such as a new part number for an upgraded component. The quantity of data in such a data base may be immense when considering the number of vehicles in some fleets, and when considering the amount of data that may be collected on a periodic basis regarding the performance of each of the vehicles. However, the computing power of modern data processing equipment makes it relatively easy to analyze 48 such a database. Various data processing routines may be used to generate performance reports 50 regarding each of the individual assets or the fleet as an entirety. Statistical data 52 may be calculated to aid in the analysis of the operating parameters of the fleet.

In order to effectively utilize the vast amount of data that may be available regarding a fleet of vehicles, the output of the analysis 48 of such data must be effectively displayed and conveyed to an interested user 14. As suggested above, there may be multiple users, e.g., users 14 and 24, interested in the data, and the level of detail of interest may vary from time to time. The inventors have found that an Internet web page is an effective means for communicating such data and information. An Internet web page may be updated 56 to reflect the performance reports 50, operating statistics 52, and/or current location map 54 for the fleet of vehicles. One or more such web pages may be utilized with appropriate hyperlinks to additional web pages. By nesting related web pages, the level of detail presented to the user 14 may be controlled by that user. For example, as the location of the vehicle may be seen on a location map, by double clicking a cursor on the symbol for a single vehicle, the speed, destination, route, cargo information including cargo weight, fuel level, driver information, and other operating information for that vehicle may be viewed on nested web pages. One user, such as a customer 24 of the transportation company, may only be interested in the location of the truck. Another user 14, such as a service technician employed by the railroad, may be interested not only in the location of the locomotive but also in the amount of fuel on board or other operating parameter. Still another user, such as personnel associated with governmental agencies may be interested in ensuring that any vehicle under their jurisdiction is in compliance with the prescribed usage of the vehicle. Any such users, e.g., 14 or 24, can quickly obtain the information they need by a simple point and click operation using known Internet browser technology.

Known search engine software technology may be provided 70 to allow a user to identify desired information related to the vehicles 12 via the global information network 15. Access to an appropriate web page including the desired information may then be provided via hyperlink directly from the search engine.

An Internet web page display used with the present invention may incorporate the full power of the multi-media capabilities of a global information network 15. For example, the location map 54 may include the use of color to indicate a readiness status for each vehicle, for example, green for a properly functioning vehicle, yellow for a vehicle exhibiting an anomaly in one of its operating parameters, and red for a vehicle having a critical fault. The user 14 of such information would be able to quickly assimilate a large volume of data and to have his/her attention directed to important portions of the data. Such a web page may also include links to additional pages including applicable governmental regulations, drawings of component parts, specifications, or operating and repair manuals or other design parameters 46. In some instances, it may be advantageous to include video information on such a web site, such as still or animated video produced by the operator of the locomotive and transmitted directly from the vehicle to show the condition of a component. Such video information may be accompanied by live audio information, including speech from the operator, thereby allowing the user 14, the operator located on the vehicle, and personnel at a service center 22 to conference regarding a developing anomaly. Communication over the global information network 15 using Internet Protocol allows packets of data to be communicated between different kinds of networks. The packets may consist of voice, text, video, audio or other types of data. The system 10 of FIG. 1 is adaptable to make use of future platforms as they become available.

When a critical fault is identified 38, or an anomaly is found to exist 58 in one or more of the operating parameters, a service recommendation may be developed 60. Information regarding the anomaly 58, critical fault 38, and/or service recommendation 60 may also be uploaded 56 to an Internet web page. When appropriate, a user may be notified 62 that new or urgent information has been displayed on the Internet web page. The user may be notified 62 by an electronic mail message, telephone call, fax or other simple form of communication. The user may then actively interact 68 with the web pages that present data regarding the vehicle of interest. Such interaction may include a request by the user for additional information. Such a request would be transmitted to the operator of the vehicle or other appropriate person via the global information network connection, and the response would be communicated in return.

The information available to the user on the Internet web page may also include information regarding services that are available 64 and/or a parts inventory 66 that may be important to any decision regarding a maintenance recommendation 60. Personnel located at a service center 22 may not only provide data for the user 14, but may also receive a communication from the user 14 regarding a planned maintenance activity, thereby facilitating the scheduling of maintenance activities at the service center 22. The speed of communication via the Internet and the breath of information that may be effectively communicated via an Internet web page make the system 10 of FIG. 1 and the method of managing assets 28 of FIG. 2 beneficial for a large fleet of vehicles distributed over a large geographic area.

Access to an Internet web page including important information regarding a fleet of vehicles may be restricted to only those users having appropriate authorization to access such data. For example, information derived from the analysis 48 of the data base may be displayed on a password protected Internet web page. Only authorized users, e.g., 14 or 24, would then be provided with the password necessary to gain access to the web page. Similarly, information received from a user and used to update the web page 56 may only be accepted as authentic if the user enters an appropriate password to confirm his/her identity. Other protection measures such as encrypting data may also be used. In some cases it may be desired to have at least a portion of the information displayed on an Internet web page be made publicly available. For example, it may be desirable to make the location map 54 for at least a portion of the vehicles available for public viewing. In the case of a passenger and/or freight transportation company, the location of autobuses may be information that can be made available on a public Internet web page, whereas the location of freight trucks may be limited to only specific industrial customers of the transportation company.

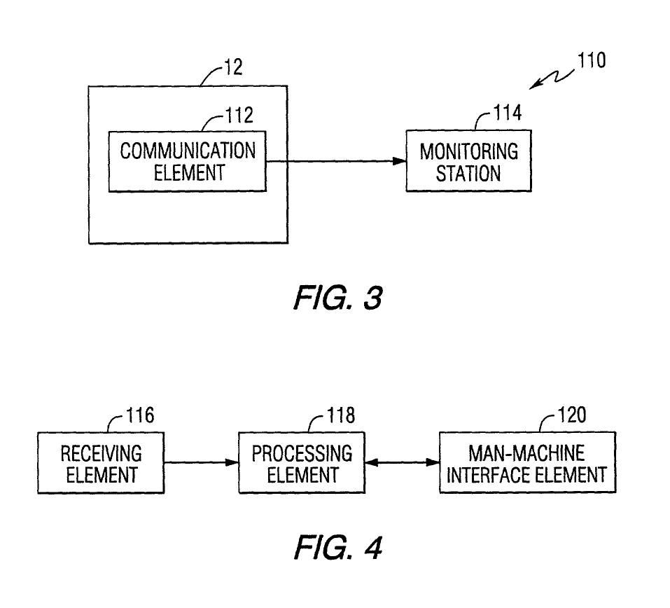

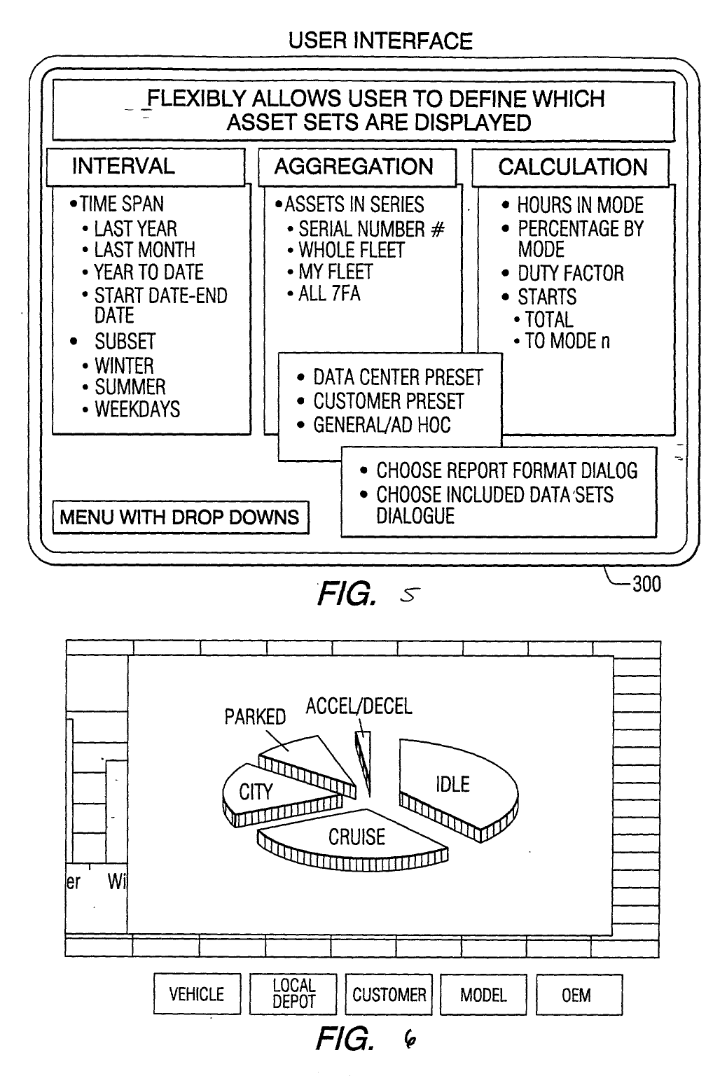

The present invention may further include a capability for predicting vehicle failure and for using such predictions to plan repair and maintenance work for each individual asset. Once data is collected from the vehicles, it may be used to develop a variety of types of information regarding the vehicles. Such a capability includes monitoring on-board systems parameter data transmitted from each vehicle as it is operating; determining whether any of the monitored data is out of a predetermined range; calculating trends for monitored data determined to be out of range; identifying any system fault; predicting when such system is likely to fail unless corrected; and predicting which, if any, system must be corrected to avoid vehicle failure, developing a service recommendation, and communicating the service recommendation via a global information network. An apparatus to accomplish such steps is generally identified by numeral 110 of FIG. 3, and it comprises one or more communication elements 112 and a monitoring station 114. The communication element(s) 112 are carried by the remote vehicle, for example locomotive 12 or truck 26. The communication element(s) may comprise a cellular modem, a satellite transmitter or similar well-known means or methods for conveying wireless signals over long distances. Signals transmitted by communication element 112 are received by monitoring station 114 that, for example, may be the maintenance facility 22 or data center 18 of FIG. 1. Monitoring station 114 includes appropriate hardware and software for receiving and processing vehicle system parameter data signals generated by locomotive 12 or truck 26 from a remote location. Such equipment, as illustrated in block diagram form in FIG. 4, comprises receiving element 116, processing element 118, and man-machine interface element 120.

Examples of suitable receiving element 116 include a satellite communications receiver or cellular communications receiver. Processing element 118 may comprise a processor, memory and modem or Integrated Services Digital Network (ISDN) adapter of a conventional personal computer or workstation coupled with software capable of executing the functions represented in FIG. 4. Suitable processing element 118 may include a diagnostic system as described in U.S. Pat. No. 5,845,272. Man-machine interface element 120 may include a monitor, keyboard, mouse, printer and/or other related I/O devices for enabling interaction between a human operator and processing means 118. Monitored vehicle parameter data received by receiving means 116 is communicated to processing element 118. It will be appreciated that in one exemplary embodiment, processing element 118 may be installed onboard the remote asset. In such embodiment, in lieu of transmitting raw data from the remote asset to the data center, the data will have been processed onboard by processing element 118. This embodiment would be less vulnerable to data link outages that may occur from time to time or data link data handling capacity. Further, such embodiment would allow for informing the operator in real time of any appropriate actions that the operator should take in connection with the operation of the vehicle.

Many vehicle system operating parameters are monitored, and trends are calculated on a subset of those parameters, or on all of the parameters. Among the parameters which may be monitored for locomotives are ambient air temperature, train notch, total track and force power, total voltage, total amps, software versions, engine RPM, engine temperature, crankcase pressure, dynamic braking, battery voltage, and voltage and amperage for all auxiliary motors. For other vehicles, such as trucks, other sets of parameters may be monitored. In one exemplary embodiment, data that may be monitored may comprise data from the vehicle “control system”, including onboard diagnostics (OBD), speedometer electronic output, brake state and other data feeds available from various vehicles subsystems. The monitored data may be used to determine a respective vehicle “operating mode”, as described in greater detail below. The monitored data may be accumulated or counted to determine the amount of time each respective vehicle has been in any given operating mode, and to determine changes and severity level in the operational modes. Examples may include braking severity and severity of acceleration. Correction factors based on ambient conditions, such as temperature, humidity, etc., may be incorporated to more accurately calculate the most suitable operational mode to be assigned. The processing elements may be configured to provide data useful to determine maintenance actions appropriate to the actual operational conditions of any given asset. Examples of the processing of such condition-based data may include respective data processing routines for determining: remaining life of oil, filters, rings, engine, brakes, etc. Other applications may include determining OEM used vehicle certification criteria, supporting insurance actuarial modifications, etc.

One exemplary matrix for determining the operational mode of the vehicle may be as illustrated in Table 1, wherein a steady state condition may correspond to meeting a respective set of rules, such as the following exemplary set of rules:

Steady State=Stable engine block temperature, e.g., inferred from oil temperature, Time of operation and ambient conditions for applicable vehicle model; and/or Stable Coolant Temperature; & Not braking; & Not Accelerating; & Not Shifting; & Not Climbing or descending

It should be noted that in the general case, each operational mode may be derived from a multi-dimensional matrix. For simplicity of illustration, in Table 1, only a first dimension is listed. Other dimensions may comprise ambient conditions, engine temperature state, vehicle weight, vehicular load including wind and incline. For example a vehicle may be in the state Accelerate Lo/Up steep hill/into headwind/hot ambient/hot engine, which may indicate a life consumption adjusting factor on the oil of ten times normal depletion, e.g., as compared to depletion in an ideal steady state cruising. The adjusting factors may be experimentally and/or empirically determined in combination with oil analyses, dynamometer measurements, engine and vehicle models. Table 2 illustrates exemplary operational modes that may be accumulated to determine the actual historical usage of the vehicle.

TABLE 1
Vehicle Operating Modes

| Vehicle | Vehicle | M&D Integer |
|---|---|---|
| Mode | Condition | Mode Value |
| OFF/Unknown | Transient | 0 |
| Idle | Transient | 1 |
| Accelerate-LO | Transient | 2 |
| Accelerate-HI | Transient | 3 |
| Braking-HI | Transient | 4 |
| Braking-LO | Transient | 5 |
| Idle with Aux. | Transient | 6 |
| Low Speed | Transient | 7 |
| Medium Speed | Transient | 8 |
| High Speed | Transient | 9 |
| High Speed | Transient | 10 |
| Climbing | | |
| Descending | Transient | 11 |
| High Torque | Transient | 12 |
| Idle with Aux. | Steady State | 13 |
| Low Speed | Steady State | 14 |
| Medium Speed | Steady State | 15 |
| High Speed | Steady State | 16 |
| High Speed | Steady State | 17 |
| Climbing | | |
| Descending | Steady State | 18 |
| High Torque | Steady State | 19 |

TABLE 2
Actual Vehicle Usage History
Vehicle Usage History

| | |
|---|---|
| Starts | Hours |
| Normal | City Driving |
| Cold | Idle Time |
| Hot | Highway |
| Stalls | High Torque |
| Load Cycles | Seasons |
| Day, Night | Winter vs. Summer |
| Weekend Usage | |

As further described below, the data monitored onboard a vehicle 19 may comprise data regarding the cargo 25 being transported by that vehicle, including cargo weight onboard the vehicle. Such data may be used to develop information regarding the cargo, and such information may be distributed via the global information network 15. A web site may be developed including information of interest to the owners of the cargo 25, such as the location of the cargo, and such owners may be provided access to the respective web pages via secured or unsecured web access via the global information network 25.

The global information network 15 facilitates the effective communication of many forms of information for improving the management of a plurality of vehicles, e.g., 12 or 26. A web site accessible through the global information network 15 and using standard Internet Protocol can present information in a variety of formats to satisfy the unique requirements of a variety of users. Such information may include failure predictions, service recommendations, the availability of service shops 22, parts and personnel, the location of a vehicle or its cargo 25, performance data, audio and video information produced on-board the vehicle, two-way communication between a vehicle and a fixed remote location 14,18,22,24, statistical information regarding the availability of the assets, repair status information, etc. It will be appreciated that the present invention need not be limited to fixed remote locations since in some instances some aspects of the management of the fleet could be conducted from a vehicle itself, such as a mobile data management trailer and the like. Web site technology, including interconnected web pages and hyperlink connectivity, may be used to present multi-media information.

FIG. 5 shows an exemplary web page that may be used for meeting a contractual obligation to report out on usage, e.g., seasonal usage of a fleet of vehicles. The user logs into a profiler web site with an appropriately authorized password and identification code. The graphical user interface (GUI) is configurable to flexibly allow for making various comparisons of actual usage of the fleet of vehicles. For example, the comparisons may be default comparisons set by the data center, or may be based on comparison requests set by the user and may accommodate general or Ad Hoc comparison requests. The user may choose from an interval menu to choose the time span to be displayed, e.g., fleet data based on last year usage for a given site, or the time span may comprise the last ten years of fleet data. If desired, the user may select from an interval subset menu and select various comparisons, e.g., seasonal comparisons, summer, winter, fall, spring, or other criteria, such as weekdays, weekends. The user may also choose from an aggregation menu to choose multiple comparisons as a function of vehicle number, or fleet number or any other criteria helpful to that user. For example, the user may be authorized to monitor only a fleet under her managerial responsibility but may not be authorized to monitor fleets operated by other fleet managers. The user may also selects calculation of a duty factor that may be defined as percentage of available output made during the interval. Upon completion of the selections, the profiler web site generates a plot and/or report, as customized by the user. FIG. 6 illustrates an exemplary “pie chart” plot that indicates the amount of time a given set of vehicles may have spend in respective operational modes, such as city driving, highway driving, idling, parked, cruising, accelerating, decelerating, loaded, unloaded, braking, hot weather, cold weather, etc.

Below are listed various exemplary embodiments that may be particularly suitable for on-road vehicles, such a fleet of trucks, autobuses, taxi cabs, etc. In one exemplary embodiment, the system would include a display device configured to display a routing for the driver that identifies which locations to stop at for “refueling” of the vehicle. The routing would identify the respective locations applicable to the route being driven by the driver for a given opportunity. The refueling could simply involve those locations which have a competitive contract price per gallon for fuel.

In another exemplary embodiment, the system would include a diagnostics routine that would help prevent air brake inspection failures. As will be appreciated by those skilled in the art, air brake inspection failures is believed to be the leading source of DOT fines involving commercial vehicles. Thus, this routine would indicate the wearing of disc pads and linings. By using standard sensor devices, it would also provide information on the air pressure level in the air lines and air-compressing equipment. It would also indicate when the brake cable is no longer functioning.

In still another exemplary embodiment, incentives or awards, conceptually analogous to “Frequent Filler Miles”, may be issued to the drivers to entice such drivers to come to preferred service stations and give them frequent filler miles toward personal vacations, awards (discounted air line tickets, hotel, etc.). The service station would be equipped with a suitable wireless data transfer device so that when the truck pulls up to the pump station, the diagnostic information would be uploaded to the central computer. It is contemplated that the truck tires may be positioned to rest on an optical tire-wear reader which records tire wear and inflation. In case of inadequate inflation and/or excessive tire wear, the diagnostic routine would provide in real time corrective actions to the operator and possibly avoid a road failure. It is further contemplated that the truck may be fitted with a quick oil connection which allows flow of oil to suitable oil viscosity and quality measuring devices, before the operator shuts off the engine. Similarly, information about idle performance may be recorded while the truck is being refueled.

It will be appreciated that the system and techniques of the present invention would allow for enhanced “On-Time” delivery service. This service is now achievable by accurately determining and coordinating GPS-based locations for truck and rail interactions to improve load and/or driver hand-offs and schedules, especially when they may have been some delays due to force majeure events.

It is believed that the system and techniques of the present invention may allow the OEM to issue extended warranties for the vehicles. For example, assuming the operator of the asset is in compliance with the condition-based service and monitoring and diagnostics services, the warranty period may be extended to, for example, up to three times the standard mile coverage. Further, the users of the vehicle may now have the ability to operate their vehicle in previously non-attainable zones because of the enhanced operational characteristics derived from having clean air filters, oil with proper lubricity, well-tuned engine, etc., due to the condition-driven maintenance. It is believed that in some sport utility vehicles, a 35% improvement in fuel consumption may be achieved as a result of such condition-driven maintenance. It is believed that vehicular leasing companies may greatly benefit from the various aspects of the present invention.

As suggested above, in one aspect of the present invention, the actual vehicle usage history may be based on a plurality of measured and or calculated parameters. Table 3 below provides an exemplary list of such parameters.

TABLE 3
Actual Vehicle Usage History

Measured Parameters
Starts-(e.g., Normal, Cold, Hot, Stalls)
Hours-(e.g., City, Idle, Highway, High Load)
Load Cycles-(e.g., Day, Night, Weekend)
Speed-(e.g., Engine, Vehicle)
Braking-(e.g., Number of Times, Force)
Environment-(e.g., Temperature, Barometer, Location, Elevation,
Weather Climbing/Downhill)
Engine Parameters-(e.g., Temperature, Oil Pressure, Voltage/Amperage)
Fault Logs
Mileage-(e.g., Trip, Total)
Calculated Parameters
Acceleration
Deceleration/Braking Level
Instantaneous/Cumulative Fuel Use
(e.g., Per Hour, Per Driver, Per Mile)

In another aspect of the present invention, trending history may be used for estimating the time before a road failure occurs. Table 4 below lists exemplary criteria that may be used for using the trending history of the vehicle.

TABLE 4
Trending/History

Trend measured and derived values to predict faults
Time under load - (e.g., Low, Medium, High Load)
Time used when not properly maintained
Time used when condition-based maintenance is used

In another aspect of the present invention, the maintenance history of each vehicle as exemplarily listed in Table 5 is reliably and quickly made available to authorized remote users for a multiplicity of uses as exemplarily listed in Table 6 below.

TABLE 5
Exemplary Maintenance/Service History

Fuel
Oil Change/Filters
Repair, e.g., brake repair, engine repair
Diagnostics for Faults/Repairs
Prognostics for Anticipated Faults

TABLE 6
Exemplary Uses of Information

Insurance
Identity Bad Actors/Repeat Offender for Repairs/Maintenance
Asset management
Resale of asset
Maintenance planning
DOT compliance
Condition-based maintenance
Asset history to evaluate needed repairs
Ordering parts and components for repairs
Tracking of vehicles and freight
Service contracts performance
Warranty claims
Leasing contracts
Better knowledge of Lease Residual Value

In another aspect of the invention, various data may be timely and reliably communicated to distinct users generally remote from one another to greatly facilitate management of a fleet of remote assets. Table 7 below provides various exemplary actions that are greatly facilitated by the present invention.

TABLE 7
Remote monitoring

Asset Management
Instructions for Repair
(Nearest recommended repair/facility)
Remote Lock/Unlock/Prevention of Starting
Text, video and audio to driver

In yet another aspect of the invention, onboard processing of data may be conducted to facilitate communication of data from the vehicle to the data center. Examples of such on-board data processing are illustrated in Table 8 below.

TABLE 8

On-Board Data Reduction
(Calculations/Trends/Fault Reporting/
Selective Data/Request only data, Vehicle
Set Points (Speed Governors))

As suggested above, condition-based dynamic maintenance planning and the utilization of such dynamic maintenance planning allows for better assessing the residual value of the vehicle. In general, such condition-based maintenance planning allows for establishing a cost/benefit evaluation of the vehicle for a proposed future plan of use in light of the state of health of the vehicle. For example, assuming the vehicle is leased, then at the time of expiration of the lease, it would be useful to the OEM to know for each vehicle how that individual asset was operated and maintained. If the asset was appropriately maintained, even though the asset was heavily used, then the residual value of that asset may be comparable or higher than the residual value of another asset with more moderate use but lacking a fully compliant maintenance program. Another potential aspect would be the utilization of such dynamic maintenance plan to manage aggregate purchase agreements. For example, automatically instructing the driver to have the vehicle serviced at a particular preferred service shop, part of a chain of service shops, with which the fleet operator has previously negotiated preferred discount rates.

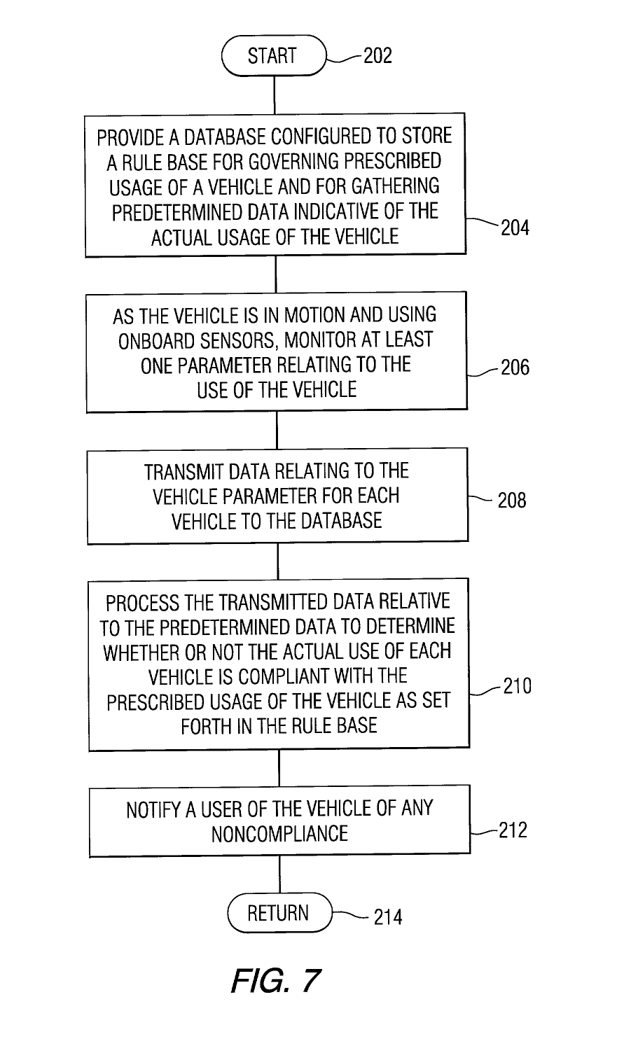

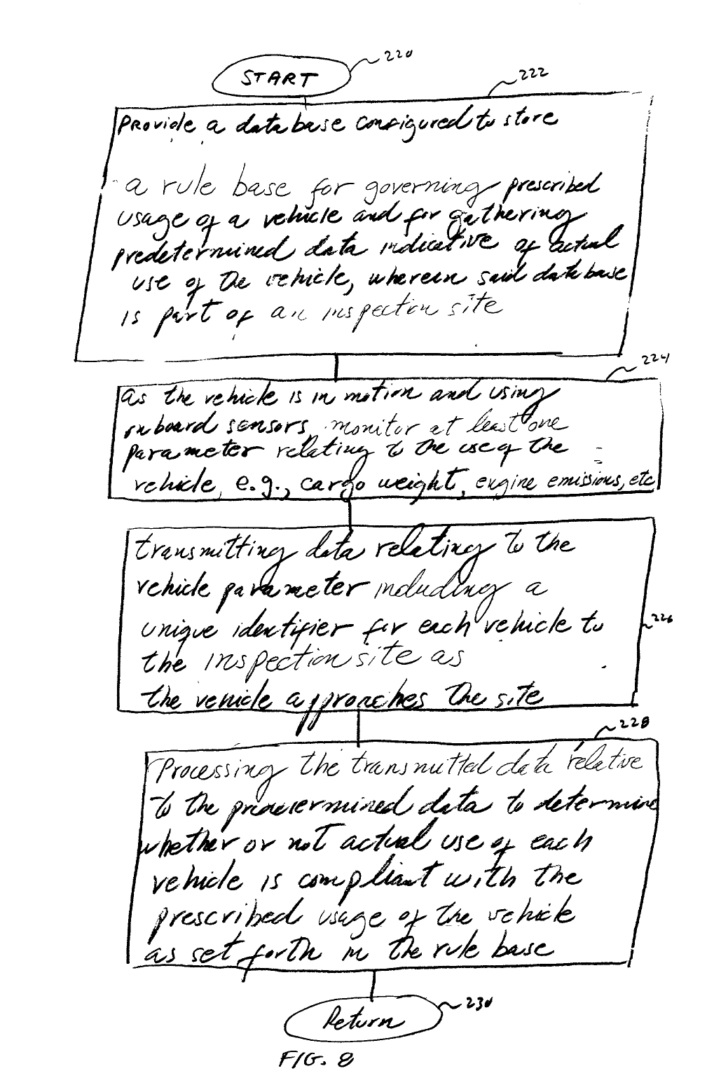

FIG. 7 shows a flowchart of a method for managing a land-based vehicle in accordance with one aspect of the present invention. Subsequent to start step 202, step 204 allows to provide a database configured to store a rule base for governing prescribed usage of a vehicle and for gathering predetermined data indicative of the actual usage of the vehicle. The rule base may include governmental rules and regulations that prescribe usage of any given vehicle. For example, the rule base may indicate the cargo weight limit of a tractor trailer. The rule base may indicate the level of emissions allowed for a given type of engine. The rule base may indicate the type of fuel allowed for a given type of engine. The rule base may indicate the number of hours the operator of a vehicle may operate that vehicle. It will be appreciated that the rule base need not be limited to government-mandated rules. For example, the owner of the vehicle could provide their own rules for governing actual usage of the vehicle. For example, the lessee of the vehicle may be under contractual obligations to the owner of the vehicle regarding the use of the vehicle. Any such contractual obligations could be included in the rule base. As the vehicle is in motion and using onboard sensors, step 206 allows to monitor at least one parameter relating to the use of the vehicle. It will be appreciated that the type of sensor to use will vary depending on the particular parameter being monitored. In one exemplary embodiment, one or more onboard weight sensors may be used to monitor cargo weight. Another suitable sensor may be used for monitoring engine emissions. Further, data relating to vehicle equipment identified in the rule base may be monitored. For example, the rule base may identify the tires or the brakes of the vehicle as requiring automated monitoring to ensure compliance of the vehicle with safety-related regulations. Step 208 allows to transmit data relating to the vehicle parameter for each vehicle to the database. Step 210 allows to process the transmitted data relative to the predetermined data to determine whether or not the actual use of each vehicle is compliant with the prescribed usage of the vehicle as set forth in the rule base. Prior to return step 214, step 212 allows to notify a user of the vehicle of any non-compliance. For example, the prescribed usage of the vehicle may indicate a cargo weight limit of two metric ton. If the actual cargo weight exceeds that limit, then the operator of the vehicle may be notified to take corrective action.

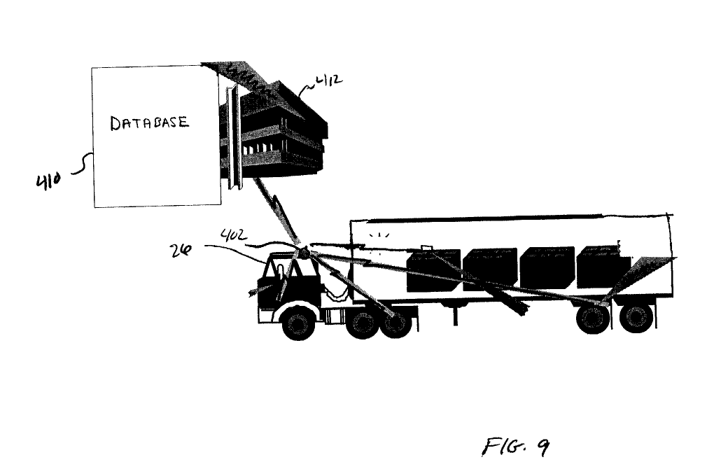

FIG. 8 shows a flowchart of a method for managing a land-based vehicle in accordance with another aspect of the present invention. Subsequent to start step 220, step 222 allows to provide a database configured to store a rule base for governing prescribed usage of a vehicle and for gathering predetermined data indicative of actual use of the vehicle, wherein the database is part of an inspection site. For example, in one exemplary embodiment, the inspection site may be associated with governmental agencies empowered to enforce rules and regulations regarding usage of the vehicle. It will be understood, however, that the inspection site need not be associated with any governmental agencies since it is contemplated that private service providers could operate the inspection station for their own business purposes and/or on behalf of the government. As the vehicle is in motion and using onboard sensors, step 224 allows to monitor at least one parameter relating to the use of the vehicle. Step 226 allows to transmit data relating to the vehicle parameter including a unique identifier for each vehicle to the inspection site as the vehicle approaches the site. It is contemplated that inspection of the vehicle “on the go”, i.e., with minimal or no stoppage of the vehicle at the inspection station, will simplify the logistics of presently known time-consuming and cumbersome procedures. Step 228 allows to process the transmitted data relative to the predetermined data to determine whether or not actual use of each vehicle is compliant with the prescribed usage of the vehicle as set forth in the rule base. In response to processing step 228, the vehicle could be flagged to stop at the inspection site in the event of non-compliance with predefined items of the rule base. For example, some of the items may involve safety issues that require immediate correction, such as braking equipment malfunctions or lack of prescribed maintenance, tire wear, excessive cargo weight, etc.

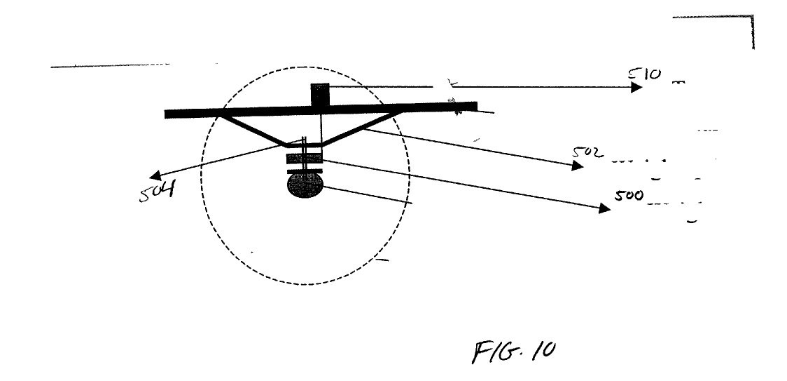

FIG. 9 illustrates an exemplary schematic of a system 400 that may be used for practicing aspects of the present invention. As shown in FIG. 9, vehicle 26 includes a data concentrator unit 402 (DCU) electro-magnetically coupled to receive signals from a suite of sensors onboard the vehicle, e.g., truck and/or tractor-trailer. As suggested above, the suite of sensors may include weight sensors, emission sensors, cargo-tag devices, operator log data, etc. As illustrated in FIG. 9, the coupling between the suite of sensors and the DCU is performed wireless. It will be understood that in some applications suitable wiring could be provided to transmit the sensor signals to the DCU. In one example, a database 410, part of an inspection site 412, receives data from DCU 402 as the vehicle 26 approaches or passes along inspection site 412.

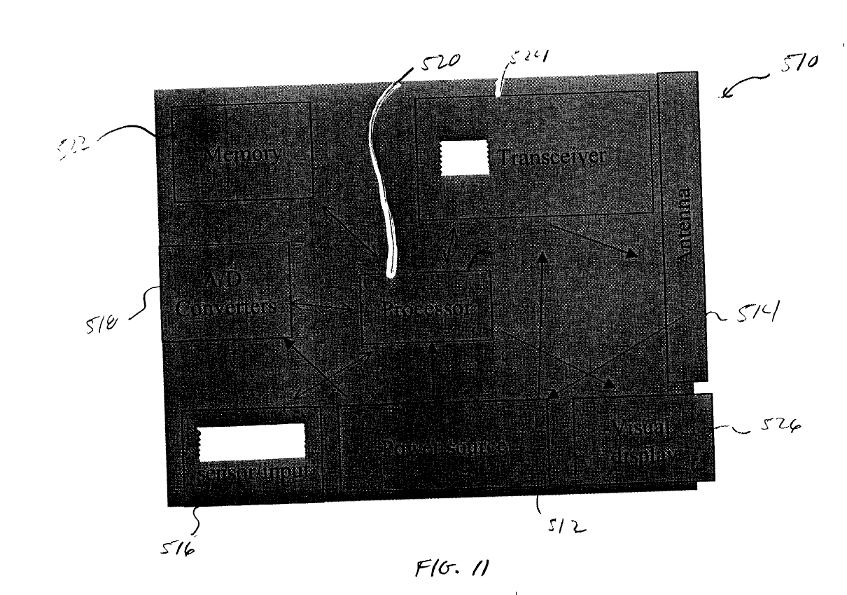

FIG. 10 includes an exemplary installation of sensors for monitoring cargo weight onboard the vehicle. As shown in FIG. 10, a weight sensor 500, such as a force transducer or piezoelectric transducer, is mechanically coupled to the suspension system 502 of the tractor-trailer though a rod or pin 504. A transponder tag 510 receives the electrical signal from sensor 500 and transmits that signal to the DCU 402 (FIG. 9) that may be installed in the cab of the truck. The DCU can be optionally configured either to convert onboard the respective raw sensor signals to a weight value using a suitable algorithm and calibration function (as may stored in a look up table) and/or transmit the converted and/or raw data to an off-board site for processing at that site. The transponder tag may comprise commercially-available devices, e.g., Radio Frequency Identification (RFID) devices such as those used for Electronic Data Identification (EDI) tags or automated toll systems. The transponder tag can be programmed to transmit cargo weight information and any other parameters indicative of the actual use of the vehicle to the inspection station for DOT or any desired business specific use. It will be appreciated that the present invention is not limited to transponder tag devices since other commercially available wireless technologies may be used if more appropriate in a given context. Examples of such technologies may include cellular communication devices, radio frequency (RF) devices, private radio, etc. The system may also provide for notification to users of any parameter having a value outside specification. Further, the system may be configured to proactively warn users, such as the vehicle operator of non-compliant conditions before the parameter actually departs from the specified value. It will be appreciated that in one exemplary embodiment, the system of the present invention may be integrated with other DOT mandated logging systems such as pre and post trip inspection checklists, and driver logs. Such data may use the same infrastructure of data storage, onboard user interfaces, communications to off board sites, e.g., DOT sites, and other government or business related applications.

As suggested above, in one exemplary embodiment the force transducers may generate a respective signal which changes as a function of cargo weight. The raw data may be collected either onboard the vehicle, off board or both, where a suitable signal conversion algorithm will be applied. As will be readily understood by those of ordinary skill in the art, such algorithm will be configured to take into account information about the truck design, such as weight of the vehicle itself, weight distribution and response of the force transducers to infer the weight of both the cargo and total system. In one exemplary embodiment, the signals indicative of weight may be subject to a calibration process previously agreed to by the relevant governing organizations. It is contemplated that the process of collection of parameters indicative of vehicle use will be approved by the governing authorities to replace some or all of the manual inspection processes presently done for determining compliance of the vehicle with any applicable rules and regulations. Such information in conjunction with vehicle identification, waybill, and log data will be communicated through wireless means, such as RFID devices and other Radio Frequency Data Collection (RFDC) devices without the vehicle having to stop at the inspection station. It is contemplated that the system of the present invention could be implemented at toll booths or independently in “truck only lanes”. It is believed that the system of the present invention will relieve congestion in truck routes caused by the need for regular inspection events. It will improve safety by proactively preventing out of compliance conditions. It will facilitate collection of apportioned tariffs and safety compliance. It will reduce fines for operators while improving asset productivity.

FIG. 11 illustrates an exemplary arrangement of a transponder tag 510 including a power source 512, such as a battery, an antenna 514, an input module 516 for receiving sensor signals, an analogue-to-digital (A/D) converter 518, a processor 520, memory 522 and a suitable transceiver 524. In one exemplary embodiment, memory 522 is configured to store a look-up table that would convert the raw sensor signal to a weight indication. The values of the look-up table may be experimentally and/or analytically derived using techniques well-understood by those of ordinary skill in the art. A visual display indication 526 may be provided to the operator of the vehicle to notify that user of noncompliance. It will be understood that Web-based communication techniques may be used to transmit the collected data to other interested users, such vehicle owner, maintenance operations, etc. In one exemplary embodiment, transceiver 524 would be responsive to a signal from a respective interrogator at the inspection site. Thus, when a vehicle equipped with the system of the present invention cruises through or along the inspection site, parameter data is automatically transmitted to a database which is part of the inspection site wherein such data may be processed using well-known correlation techniques to determine essentially in real time and on the fly whether any given vehicle is compliant with a rule base that prescribes the use of the vehicle. It will be understood that the present invention is not limited to the tag transponder illustrated in FIG. 11 since it will be apparent to those skilled in the art that other tag devices including passive tag devices can be used for the purposes of practicing the invention.

Vehicles Information Services

In another aspect of the present invention, the fleet data management tools of the present invention allow for providing enhanced services in connection with the fleet of remote assets by:

Enhancing residual value of the asset by retrofitting data collection and processing devices to provide various data management services

Enhance initial value of the asset by inclusion of such devices as original equipment

As suggested above, such data management services may include some or all of the following services:

1. Electronic and remote hosting of computer-readable maintenance records in support of compliance with governmental agencies, e.g., Department of Transportation (DOT), condition based maintenance planning, historical asset utilization

2. Usage profiling, such as may provided by accurately determining actual usage of any individual asset, e.g., monitoring, as a function of time, available control system data such as tachometer, odometer, fuel flow, and/or environmental parameters such as temperature, altitude, humidity, etc. The usage profiling may be performed in conjunction with host data archival services used in support of various processes encountered during the operation of the fleet of assets, such as fleet maintenance scheduling, engine optimization for fuel efficiency, compliance of driver sleep and/or speed requirements, logistics planning and may include information from terrain and/or weather maps where the vehicle has traveled.

3. Value added services based on some or all of the preceding stored knowledge, with or without the assistance of processing or expert systems that may be developed in conjunction with the gathering of historical performance data to establish data-driven signatures or triggers for maintenance escalation.

4. Such systems may include:

Storing onboard and/or off board engine or other subsystem related models

trending of measured and derived parameters and comparison to expected values to indicate anomalous conditions

Exceeding dynamically calculated maintenance intervals for use in operational changes

Scheduling maintenance and/or Pre-ordering needed parts for remediation and improvement.

Maintenance plans optimized for the fleet as opposed to just a single vehicle.

5. Non-maintenance related information services may include some or all of the following:

Use of position and usage information in support of logistics both track and trace and match load requirements

Interaction with aggregate purchase agreements to direct equipment operators to outlets for the covered material

Virtual real time data messaging to/from driver

6. Basic remote control of remote assets via secure communication such as

Locking or unlocking of access doors/windows

Preventing vehicle start

7. It is contemplated that such services could be provided as stand alone service contracts in association with purchase of enabling retrofit of already deployed assets or in connection with deployment of new models. Alternatively such services could be provided as part of contract service agreements or in conjunction with delivery of performance guarantees and full scope leasing arrangements. In one exemplary embodiment, the assignee of the present invention may advantageously leverage domain knowledge created through its GE Fleet Services or in connection with commercially available leasing services, e.g., Penske Truck leasing, to create a business process to be electronically-enabled for application in private fleet garages.

In operation, the system and techniques of the present invention are believed to provide the following:

1) A combination of devices performing data concentration, data communications, data reduction, data processing, archival and marketing to provide the following:

Data acquisition onboard of vehicles to gather, store and preprocess data from the electronic control systems, additional sensors (GPS, ambient conditions and others), and accessory subsystems such as “cherry pickers” or drilling rigs.

Such system to be remotely upgradable in software and/or diagnostic algorithm tuning parameters

Such system to support modifications of controls set points such as governor settings based on central or distributed decision making by experts or the system itself.

Such data processing configured to identify anomalous conditions that may require escalation and communication either through annunciation in the cab, remote real time communications or periodic data dumps at properly designated way points

Communications capabilities with on board real time system using GPS, cell phones, satellite-based communications, etc.

Radio Frequency (RF) (both long and short range), Infrared (IR) for wireless communications at way points (during fueling for example)

Wired functionality at service shops

Remote data center or centers aggregating data, processed data, fleet information, dynamically revised models and anomaly triggers, off board expert systems

To create operations and maintenance action recommendations to be communicated through, phone, pager, e-mail or other feedback systems including direct interaction with the data concentrator or its communications modules

2) It is believed that the system and techniques of the present invention allow the assignee of the present invention to provide more timely and cost effective services for managing a fleet of remote assets, including leasing of a fleet of vehicles by providing the following:

Improved driver satisfaction and compliance of maintenance of the asset which directly improves the residual value of the asset,

More robust aggregate purchase agreements because timely delivery of fleet-related data allows for more effective use of such purchase agreements,

new services such as freight or vehicle tracking and utilization advice,

broader reach to non-GE service shops through sharing of advantageous GE business practices

offering of performance guarantees based on estimated cost of operation per mile including cost of fuel and tires.

The present invention can be embodied in the form of computer-implemented processes and apparatus for practicing those processes. The present invention can also be embodied in the form of computer program code including computer-readable instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. When implemented on a computer, the computer program code segments configure the computer to create specific logic circuits or processing modules.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

What is claimed is:

1. Method for managing a land-based vehicle, the method comprising:
providing a database configured to store a rule base for governing prescribed usage of a vehicle and for gathering predetermined data indicative of the actual use of the vehicle;
as the vehicle is in motion and using onboard sensors, monitoring at least one parameter relating to the use of the vehicle;
transmitting data relating to the vehicle parameter for each vehicle to said database;
processing the transmitted data relative to the predetermined data to determine whether or not the actual use of each vehicle is compliant with the prescribed usage of the vehicle as set forth in said rule base; and
notifying a user of the vehicle of any non-compliance.

2. The method of claim 1 wherein the user is selected from the group comprising government agencies, vehicle owners, customers of vehicle services, vehicle operators, maintenance personnel and service centers.

3. The method of claim 1 wherein the vehicle parameter comprises cargo weight.

4. The method of claim 1 wherein the prescribed usage of the vehicle comprises government-mandated prescribed usage and the vehicle parameter is selected from the group comprising cargo weight, data relating to vehicle equipment identified in the rule base, and operator log data.

5. The method of claim 4 wherein the data related to vehicle equipment comprises engine emission data, and brake system data.

6. The method of claim 2 further comprising providing information derived from the processing step to users via an internet web page.

7. The method of claim 1 wherein said processing step comprises correlating the transmitted data to the predetermined data to determine whether or not the actual use of the vehicle is compliant with the prescribed usage of the vehicle.

8. The method of claim 1 wherein said database is part of an inspection site and wherein the transmission of data regarding the vehicle parameter occurs as the vehicle passes along said inspection site.

9. The method of claim 1 wherein said database is part of an on-board device configured to perform the notifying step.

10. The method of claim 1 further comprising providing a unique identifier for each vehicle and associating said identifier with each respective vehicle parameter.

11. The method of claim 1 wherein the information derived from the database is selected from the group comprising inspection reports, maintenance reports and operator log reports.

12. The method of claim 1 wherein the parameter monitored as the vehicle is in motion further comprises parameters indicative of the environment in which the vehicle operates.

13. Method for managing a land-based vehicle, the method comprising:
providing a database configured to store a rule base for governing prescribed usage of a vehicle and for gathering predetermined data indicative of actual use of the vehicle, wherein said database is part of an inspection site;
as the vehicle is in motion and using onboard sensors, monitoring at least one parameter relating to the use of the vehicle, said parameter including at least cargo weight;
transmitting data relating to the vehicle parameter including a unique identifier for each vehicle to the inspection site as the vehicle approaches said site; and
processing the transmitted data relative to the predetermined data to determine whether or not actual use of each vehicle is compliant with the prescribed usage of the vehicle as set forth in said rule base.

14. The method of claim 13 further comprising, in response to said processing step, flagging the vehicle to stop at said site in the event of non-compliance with predefined items of said rule base.

15. The method of claim 13 further comprising providing information derived from the processing step to users via an internet web page.

16. The method of claim 15 wherein a user is selected from the group comprising government agencies, vehicle owners, customers of vehicle services, vehicle operators, maintenance personnel and service centers.

17. The method of claim 13 wherein the vehicle parameter is selected from the group comprising cargo weight, data relating to vehicle equipment identified in the rule base, and operator log data.

18. The method of claim 13 further comprising notifying a user of the vehicle of any noncompliance.

19. The method of claim 13 wherein the information derived from the database is selected from the group comprising inspection reports, maintenance reports and operator log reports.

20. A system for managing a land-based vehicle, the system comprising:
a database configured to store a rule base for governing prescribed usage of a vehicle and for gathering predetermined data indicative of actual use of the vehicle;
onboard sensors configured to monitor, as the vehicle is in motion, a parameter relating to the use of the vehicle;
a transceiver configured to transmit data relating to the vehicle parameter for each vehicle to said database;
a processor coupled to said database to determine whether or not the actual use of each vehicle is compliant with the prescribed usage of the vehicle as set forth in said rule base; and
a module configured to notify a user of the vehicle of any non-compliance.

21. A system for managing a land-based vehicle, the system comprising:
a database configured to store a rule base for governing prescribed usage of a vehicle and for gathering predetermined data indicative of the actual use of the vehicle, wherein said database is part of an inspection site;
onboard sensors configured to monitor, while the vehicle is in motion, a parameter relating to the use of the vehicle;
a transceiver configured to transmit data relating to the vehicle parameter including a unique identifier for each vehicle to the inspection site as the vehicle approaches said site; and
a processor coupled to said database to determine whether or not the actual use of each vehicle is compliant with the prescribed usage of the vehicle as set forth in said rule base.

22. The system of claim 21 further comprising a module coupled to said processor, said module configured to flag the vehicle to stop at said site in the event of non-compliance with predefined items of said rule base.
